(19) United States
(12) Patent Application Publication
(10) Pub. No.: US 2017/0268825 A1
(43) Pub. Date: Sep. 21, 2017

(54) Elbow for a Tube Bundle Heat Exchanger for Large Product Pressures, Method for Producing a Tube Bundle Heat Exchanger Comprising such an Elbow, and Use of a Tube Bundle Heat Exchanger for Large Product Pressures with such an Elbow in a Spray Drying System

(71) Applicant: GEA TDS GmbH, Sarstedt (DE)

(72) Inventors: Brigitte Schlag, Coesfeld (DE); Uwe Schwenzow, Ahaus (DE); Ulrich Rolle, Everswinkel (DE); Dietrich Zimmermann, Hallstadt (DE); Markus Grimm, Klein Zecher (DE); Matthias Terlinde, Ahaus (DE); Wolfgang Jäckering, Emsbüren-Berge (DE)

(73) Assignee: GEA TDS GMBH, Sarstedt (DE)

(21) Appl. No.: 15/505,840

(22) PCT Filed: Aug. 13, 2015
(86) PCT No.: PCT/EP2015/001664

§ 371 Date: Feb. 22, 2017

(30) Foreign Application Priority Data
Aug. 22, 2014 (DE) 10 2014 012 279.4

(51) Int. Cl. F28D 7/06; B23K 20/12; B23K 20/02; F28F 9/26; F28F 13/08

(52) U.S. Cl. CPC F28D 7/06; F28F 9/26; F28F 13/08; B23K 20/023; B23K 20/129; F28F 2275/06; B23K 2203/05

(57) ABSTRACT

A manifold with a circular cross-section having a deviation angle of 180 degrees for a tube bundle heat exchanger for large product pressures has a first and second flange on each inlet and outlet. The manifold has two manifold halves respectively made of a single piece, and each half comprises a joining point on an end facing away from a flange. The manifold halves are connected together on the associated joining point. Extension of the passage cross-section of each manifold half is formed by rotationally symmetrical through openings, from which at least one of the flanges and at least one of the joining points extends in the respective coaxial arrangement on rotational axes. First and second axes of through openings of the first manifold halves and third and fourth axes of through openings of the second manifold halves extend on a common plane representing a meridian plane for each flange.

### TECHNICAL FIELD

The invention relates to an elbow with a circular cross-section having a deflection angle of 180 degrees for a tube bundle heat exchanger for large product pressures, having a flange on each inlet and outlet of the elbow, and a method for producing such an elbow. Moreover, the invention relates to a tube bundle heat exchanger for large product pressures with such an elbow with series-connected tube bundles arranged in parallel, wherein a product flows through the inner tubes of the tube bundle and, viewed in the direction of flow of the product and with reference to any desired tube bundle, an outlet of the tube bundle is fluidically connected to an inlet of an adjacent downstream tube bundle. Alternatively, an inlet of the tube bundle is fluidically connected to an outlet of an adjacent, upstream tube bundle via the elbow with a deflection angle of 180 degrees. The invention moreover relates to the use of a tube bundle heat exchanger for large product pressures in a spray drying system.

### BACKGROUND

Powdered food products, in particular milk products such as easily-soluble foods for small children, are produced in many cases by atomization or spray drying in a so-called drying tower. There, a primarily low viscosity initial product previously concentrated to a specific amount of dry substance in an evaporator, or respectively a condenser, and then heated in a heater to a specific temperature in a hot air stream, is atomized either through discs or, as in the present preferred case through a nozzle, in particular a single substance nozzle. The initial product leaving the heater is fed to this nozzle by means of a high-pressure piston pump, a so-called nozzle pump, at a pressure that can reach up to about 300 bar. A significant difference in height between the nozzle pump that is arranged in the bottom outer region of the drying tower, and the nozzle that is located in the so-called hot chamber in the headroom of the drying tower, is bridged by a riser that intentionally or necessarily also functions as a thermal maintenance line.

To ensure the longest possible and hygienically safe storage of the powdered food product, the end product must exhibit effective solubility and be as sterile as possible. The required sterility is achieved by killing microorganisms to the greatest extent possible in the initial product leaving the heater by conveying the concentrate with a suitable temperature and dwell time characteristic, and by including in the equation the riser to the nozzle functioning as a thermal maintenance line. A maximum temperature of 77° C. is required to produce a so-called “low heat powder”, approximately 85° C. is required to produce so-called “high heat powder”, and up to 125° C. is required to produce “ultra high heat powder”.

The necessary average dwell time of the initial product in the riser after prior high-pressure treatment together with a hot temperature undesirably influences the solubility of the end product. Furthermore, being kept hot for a long time in the riser leads to a denaturing of the initial product. This generally also means that the quality of the end product is reduced. Such a denaturation can for example influence the powder quality of baby food so that there is no more guarantee of it being completely soluble, which causes unacceptable lumps in the prepared baby foods.

An improvement of the microbacterial status of the initial product before the evaporator, such as by sterilization through microfiltration, is known; this is involved, but nonetheless improves the microbacterial status of the end product.

The necessary sterility up to the inlet of the nozzle can also be threatened by the nozzle pump since it cannot convey the initial product under aseptic conditions with a reasonable technical outlay. Aseptic conveying conditions require a significant technical outlay, however, which in practice generally is not or cannot be realized. Germs from the surrounding air can enter the initial product through the pistons of the nozzle pump so that reinfection occurs at that location. The powdered end product can therefore be contaminated, and the contamination increases over time under the effect of the residual moisture normally remaining in the end product.

In the state-of-the-art, aseptic conveyance of the liquid initial product leaving the heater to the nozzle pump arranged downstream is only feasible with greater technical outlay. To achieve the necessary sterility of the liquid initial product exiting the nozzle pump under high pressure, an appropriate thermal treatment of this initial product could be provided in a high-pressure heat exchanger along the path to the nozzle. This high-pressure heat exchanger could be arranged directly before the nozzle, which would obviate the previously necessary riser with its aforementioned negative effects. This arrangement would also still permit the operation of a nozzle pump with non-aseptic delivery.

In this context, it has already been proposed that the high-pressure heat exchanger be designed as a sufficiently pressure-resistant helical monotube which is supplied with steam for heating from the outside. This proposal is however not expedient because an even supply of heat over the outside and over the entire length of the monotube, and hence an even dwell time for all the particles of the initial product flowing through the monotube, are not ensured.

A heat exchanger that satisfies the requirements of a sufficiently even supply of heat and an equivalent dwell time for all of the particles of the initial product would basically be a so-called tube bundle heat exchanger that in principle could take the place of the aforementioned monotube. However, such a solution would fail given the fact that such tube bundle heat exchangers have to date not been available for product pressures up to 300 bar.

The basic design of a tube bundle heat exchanger is for example described in DE 94 03 913 U1. DE 10 2005 059 463 A1 also discloses such a tube bundle heat exchanger and furthermore discloses how a number of tube bundles in this heat exchanger can be arranged in parallel and series-connected for the passage of liquid by means of connecting bends or connecting fittings. Such an arrangement is shown in FIG. 1 of this application.

The product to be heat-treated flows through the inner tubes. Dimensioning the inner tubes themselves and their incorporation into a so-called tube support plate on either side to be sufficiently pressure resistant for the high product pressures in the context of the application briefly outlined above does not present a person skilled in the art pursuing a suitable high-pressure tube bundle heat exchanger with the actual problem. Sufficiently dimensioning the wall thickness of the inner tubes renders the actual tube bundle and its incorporation in the tube bundle carrier plates on both sides resistant to pressures including up to 300 bar, or even slightly above.

The aforementioned connecting bend or connecting fittings with flanges according to FIG. 1 are not available in a stainless steel quality suitable for food production that can withstand such pressures, and that bridge the relatively close spacing of the tube carrier plates to be connected with a correspondingly large curvature, i.e., with a relatively small curvature radius, and thereby represent the necessary spacing of the flanges—which is precisely dictated by the adjacent tube carrier plates—in a manner that is also very dimensionally accurate and consistent, preferably within a range of a tenth of a millimeter. The conventional wall thicknesses of commercially available elbows with a 180 degree deflection are, however, suitable at most for process pressures in the low double-digit range.

In the following, the term “elbow” which is conventional in fluid mechanics will be consistently used for the relevant connecting bend or connecting fitting with a deflection angle of 180 degrees resulting from the described use.

### SUMMARY

For a long time, experts have been looking for a solution of how to exploit the advantages that would arise from an arrangement of a suitable high-pressure heat exchanger that is arranged directly before or at a short distance from the nozzle in the drying tower. The advantages are significant and comprise the following.

By arranging a high-pressure tube bundle heat exchanger in this manner, the exit temperature at the heater, and correspondingly also at the nozzle, can be increased by 1 to 4° C. with the same powder quality.

The prospect exists of also using the presented high-pressure tube bundle heat exchanger according to the invention for an UHT treatment of the initial product up to the aseptic range with the goal of producing so-called “ultrahigh heat powder”.

Increasing the temperature of the initial product exiting the nozzle by 1° C. yields an increase in efficiency, i.e., an increase in the volume output of the drying tower of 2.5 to 3% according to ((2.5-3)%/1° C.)

An object of the present invention is to create an elbow for a tube bundle heat exchanger for large product pressures that possesses the required strength and consistent dimensional accuracy, that can be optimized in terms of fluid mechanics while it is being manufactured to minimize elbow loss and the tendency toward product deposits, and effective cleaning from the flow exists. Moreover, another object of the invention is to present a production method for such an elbow, a tube bundle heat exchanger with such an elbow, and a use of a tube bundle heat exchanger for large product pressures with such an elbow in a spray drying system.

An elbow according to the teachings herein with a deflection angle of 180 degrees is consistently designed over the entire progression of its passage cross-sections in the form of circular cross-sections, and it has a flange at each end. These flanges are screwed to the associated tube bundle. To accomplish this, the flanges possess through-holes arranged distributed in a hole circle for the bolts of the respective threaded connecting means being used. The latter can be a through bolt, a stud bolt, or a cap screw, wherein the respective bolted connections are all designed so that they reliably withstand the high forces arising in the high-pressure tube bundle heat exchanger.

The invention is based on a tube bundle heat exchanger as disclosed in DE 10 2005 059 463 A1, wherein the inner tubes are dimensioned with regard to their wall thickness and the incorporation of the inner tubes in the respective end-side tube carrier plate so that the overall construction withstands pressures up to 300 bar or slightly more. The individual tube bundles are connected to each other in the above-described manner by means of the elbows according to the teachings herein.

The elbow consists of two elbow halves, which are respectively made of a single piece. Each elbow half has a connecting point at its end facing away from the flange, and the elbow halves are integrally bonded to each other at the associated connecting point. To produce the integrally bonded connection, welding methods with and without additional material, friction or pressure welding methods, are preferably used. The elbow halves are expediently produced from round material and from a whole piece by machining. Available and sufficiently known machining methods are drilling, turning and milling that can be performed sequentially or in parallel on so-called multi-axis machining centers. These machining methods make it possible to produce the progression of the passage cross-sections of each elbow half through rotationally symmetrical passages. At least one passage extends from the flange on the one hand and at least one passage extends from the associated connecting point on the other hand in a coaxial arrangement on rotational axes. The first and second rotational axis of the passages of the first elbow half, and the third and fourth rotational axis of the passages of the second elbow half, extend in a common plane that represents a meridian plane for each flange. The first and second rotational axis intersect at a first intersection, and the third and fourth rotational axis intersect at a second intersection. The first intersection is associated with a penetrating first passage on the first rotational axis, and a penetrating second passage on the second rotational axis that only penetrate each other on one side and not completely. In the same manner, the second intersection is associated with a penetrating third passage on the third rotational axis, and a penetrating fourth passage on the fourth rotational axis that also only penetrate each other on one side.

In order to minimize the flow loss in the elbow and prevent uneven cross-sectional transitions at which product can become deposited and collect, which would render cleaning in the flow difficult, one suggestion proposes providing a convex rounding with an outer curvature radius in the radial outer progression of the associated passage cross-section of the respective elbow half, and a concave rounding with an inner curvature radius in the radial inner progression of the associated passage cross-section at the mutually penetrating passages. The dimensions are expediently chosen so that at least the convex rounding can be produced by machine. The elbow loss at the inner curvature is strongly reduced when the interruptions at this location are reduced. This is achieved with the elbow described herein by a largest possible inner curvature radius.

When the mutually penetrating passages are designed in the shape of a conical frustum and their respective tapering is oriented toward the associated first or second intersection as provided by another proposal, an acceleration of the main flow is achieved by the tapering passage cross-section, and accordingly a reduction of the interruptions in the inner curvature and, as a final result, a reduction of the elbow loss.

From fluid mechanics, it is known that a certain cross sectional expansion at the peak is useful with elbows having the same inlet and outlet cross-section, which leads to reduced elbow loss. In the elbow described herein, this fact is exploited in that a peak cross-section of the elbow half is expanded relative to the peak cross-section of adjacent passage cross-sections to either side. This expansion and the condition of an equivalent inlet and outlet cross-section are easy to achieve with the elbow because the passages can easily be adapted to the desired cross-sectional progression by machining forming processes. This makes it possible to optimize the elbow in terms of fluid mechanics relative to so-called standard bend, or respectively the “normal” elbow.

The progression of the passage cross-sections of the respective elbow half is expediently formed by more than one rotationally symmetrical passage proceeding on the one hand from the flange and on the other hand from the connecting point. In this case, the rotationally symmetrical passages are lined up with the same diameter at their respective transition point to an adjacent passage. Although this embodiment no longer has any more sudden transitions, it can, however, still be optimized in terms of fluid mechanics with regard to the reduction of elbow loss when the transition points are continuously designed curved as is also proposed.

The machining of the passage cross-sections of the respective elbow half is significantly simplified when the rotational axes always run in a straight line.

As a final result, the elbow according to the teachings herein should have a deflection angle of 180 degrees. This goal is achieved in principle independent of whether the two elbow legs of the respective elbow half have an acute, oblique or right angle. The most beneficial elbow shape in terms of fluid dynamics, and simultaneously the easiest to create, results when the first and second rotational axis and the third and fourth rotational axis intersect each other at a right angle, i.e., at an angle of 90°, as provided in an advantageous embodiment. According to another proposal, an additional significant simplification of production exists when the elbow halves are designed congruent, and the variety of parts for producing the elbow is accordingly reduced to a single embodiment of an elbow half.

The integral bond of the connection sites is preferably a weld connection, which in turn is preferably performed in a multilayer orbital manner.

To ensure consistent dimensional accuracy of the spacing of the flanges of the joined elbow, which is to be kept very precise and deviations of which cannot be compensated or corrected by the two tube bundles to be connected by the elbows, due to their very dimensionally accurate spacing, without leaks arising at the sealed connecting points, one advantageous embodiment stipulates providing a contact surface on each flange that is orientated in a plane parallel to an end face of the connecting point, and that stands back relative to the end face by a degree of shrinkage. This degree of shrinkage is dimensioned so that, after producing and cooling the connection between the two elbow halves to the complete elbow, the two contact surfaces lie against each other and thereby produce an immovable and undeformable spacing between the two flanges for their dimensional final processing.

A production method according to the invention for an elbow having the above-described features provides producing the respective elbow half from a round material in a first production step, and from a whole piece by machining. An inner contour consisting of rotationally symmetrical passages and a first outer contour that is not directly adapted to the tube bundle heat exchanger, or respectively its tube bundles, are provided with a respective end contour, and a second outer contour is processed beforehand that is directly adapted to the tube bundle heat exchanger, or respectively its tube bundles. In a second production step, the two elbow halves are then integrally bonded to each other at their respective connecting point to the elbow. The integral bond is preferably produced by a manual or mechanical orbital welding method which can be carried out in one or more layers. The welding method can also be a friction or press weld. In a third production step, the second outer contour adapted to the tube bundle heat exchanger, or respectively its tube bundles, is provided in each case with an end contour by machining.

With regard to a consistent dimensional accuracy of the produced elbow, it is advantageous when stress-relief annealing is performed at least once following the conclusion of the welding method, or during the multi-layer welding method.

In order to ensure an immovable and undeformable spacing between the two flanges for their dimensional end processing, one advantageous design of the production method provides positioning a contact surface provided on each flange by a degree of shrinkage such that, after producing the integral bond, a mutual contacting of the contact surfaces resulting from contraction by cooling the regions of the elbow heated during integral bonding ensures that the second outer contour is produced with the dimensionally accurate end contour.

A tube bundle heat exchanger according to the invention for large product pressures possesses series-connected tube bundles arranged in parallel, wherein a product flows through inner tubes of the tube bundle and, viewed in the direction of flow of the product and with reference to any desired tube bundle, an outlet of the tube bundle is fluidically connected to an inlet of an adjacent downstream tube bundle. Alternatively, an inlet of the tube bundle is fluidically connected to an outlet of an adjacent, upstream tube bundle via an elbow with a deflection angle of 180 degrees. An elbow is used in each case that has the above-described features.

The use of a tube bundle heat exchanger as described within for large product pressures with an elbow as also described herein in a spray drying system provides that the tube bundle heat exchanger is arranged directly before or at a short distance from the nozzle in the drying tower.

By means of the described invention, the aforementioned and desired advantages can result. Namely, by arranging a high-pressure tube bundle heat exchanger in this manner, the exit temperature at the heater, and correspondingly also at the nozzle, can be increased by 1 to 4° C. with the same powder quality. Further, increasing the temperature of the initial product exiting the nozzle by 1° C. yields an increase in efficiency, i.e., an increase in the volume output of the drying tower of 2.5 to 3%.

### BRIEF DESCRIPTION OF THE DRAWINGS

FIG. 1 shows a middle section of a so-called tube bundle as a modular part of a tube bundle heat exchanger which may consist of a plurality of such tube bundles, wherein a well-known, commercially available elbow in the form of a circular connecting bend is arranged on each side.

A detailed representation of the invention is given in the following description and the accompanying figures of the drawing and from the claims. Whereas the invention is realized in a wide variety of embodiments, the drawing depicts a preferred exemplary embodiment of the elbow for large product pressures according to the invention and will be described below with regard to its design, production method and use in a high-pressure tube bundle heat exchanger.

FIG. 2 shows a meridian section of a preferred embodiment of an elbow half of the elbow according to the invention according to a section identified as C-D in FIG. 4.

FIG. 3 shows a perspective representation of an elbow half according to FIG. 2 parted in the meridian section.

FIG. 4 shows a perspective representation of a view of the elbow half according to FIG. 2.

FIG. 5 shows a meridian section of the elbow according to the invention joined with two congruently designed elbow halves according to FIG. 2.

FIG. 6 shows a meridian view and section of the inner contour of the elbow half according to FIG. 2 at the deflection region.

FIG. 7 shows a perspective representation of the parted elbow half according to FIG. 2 in the meridian section at the deflection region to depict the penetration in the region of the inner curvature.

### DETAILED DESCRIPTION

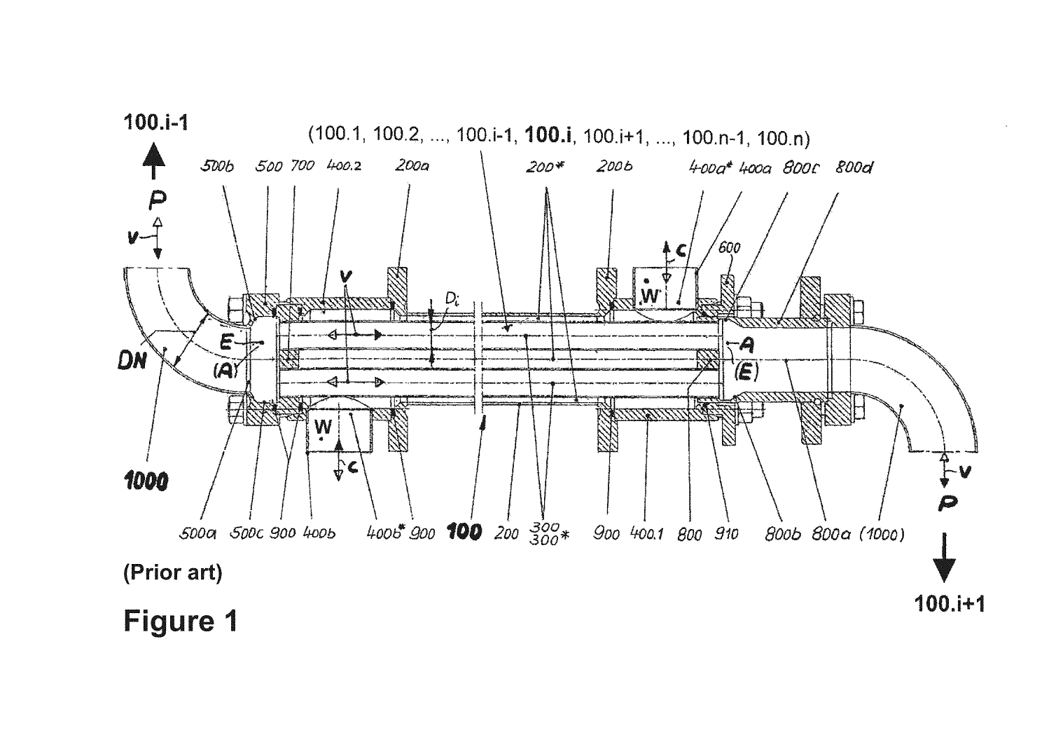

The middle part of a tube bundle heat exchanger 100, which is normally composed of a plurality (a number n) of tube bundles 100.1 to 100.n (generally: 100.1, 100.2, . . . , 100.i−1, 100.i, 100.i+1, . . . , 100.n−1, 100.n) in the prior art is shown in FIG. 1. The bundle 100.i designates an arbitrary tube bundle (see also DE 94 03 913 U1) consisting of an outer jacket 200 bordering an outer channel 200* with a fixed-bearing-side outer jacket flange 200a arranged on the left side with reference to the depicted position, and a floating-bearing-side outer jacket flange 200b arranged on the right side. Abutting the latter is a first cross channel 400a*, which is bordered by a first housing 400.1 and has a first coupling 400a, and a second cross channel 400b*, which is bordered by a second housing 400.2 and has a second coupling 400b and abuts the fixed-bearing-side outer jacket flange 200a. A number of inner tubes 300, which extend axially parallel with the outer jacket 200 through the outer channel 200* and jointly form an inner channel 300* and each have a tube inner diameter Dᵢ, said number starting for example with four and then also increasing up to 19 and possibly more in number, is braced at the end in each case in a fixed-bearing-side tube carrier plate 700, or respectively a floating-bearing-side tube carrier plate 800 (both of which are also designated a tube mirror plate), where they are sealingly welded therein. This overall arrangement is introduced through an opening (not shown) in a second housing 400.2 into the outer jacket 200 and clamped by means of a fixed-bearing-side exchanger flange 500 to the second housing 400.2 with an intermediate seal 900 in each case, preferably a flat seal (fixed bearing 500, 700, 400.2).

The two housings 400.1, 400.2 are also sealed with a seal 900 against the adjacent outer jacket flange 200b, 200a, wherein the first housing 400.1 arranged on the right side in conjunction with the outer jacket 200 is pressed against the fixed bearing 500, 700, and the second housing 400.2 is arranged on the left side by means of a floating-bearing-side exchanger flange 600 with an intermediate, preferably O-ring 910. The floating-bearing-side tube carrier plate 800 extends through a hole (not shown) in the floating-bearing-side exchanger flange 600 and is sealed against the latter by means of the dynamically stressed O-ring 910 that moreover statically seals the first housing 400.1 against the floating-bearing-side exchanger flange 600. The latter and the floating-bearing-side tube carrier plate 800 form a so-called floating bearing 600, 800 that permits the changes in length of the inner tubes 300 welded in the floating-bearing-side tube carrier plate 800 that arise from a change in temperature in both axial directions.

Depending on the arrangement of the respective tube bundle 100.1 to 100.n in the tube bundle heat exchanger 100 and its respective configuration, a product P can flow through the inner tubes 300 from left to right or vice versa relative to the depicted position, wherein the average flow speed in the inner tube 300, and hence in the inner channel 200* is designated v. The cross section is generally designed so that this average flow speed v also exists in a connecting bend 1000 that is connected on the one hand to the fixed-bearing-side exchanger flange 500, and on the other hand directly to a floating-bearing-side coupling 800d that is securely connected to the floating-bearing-side tube carrier plate 800. By means of the two connecting bends 1000 (so-called 180 degree elbows), one half of each is depicted in FIG. 1, a relevant tube bundle 100.i is series-connected to an adjacent tube bundle 100.i−1, or respectively 100.i+1. The fixed-bearing-side exchanger flange 500 therefore first forms an inlet E for the product P, and the floating-bearing-side coupling 800d accommodates an associated outlet A. With each adjacent tube bundle 100.i−1, or respectively 100.i+1, this inlet and outlet configuration correspondingly reverses.

The fixed-bearing-side exchanger flange 500 has a first connection opening 500a that corresponds to a nominal diameter DN. Hence, a corresponding nominal passage cross-section of the connecting bend 1000 connected at that location, and which is generally dimensioned so that the existing flow speed at that location, corresponds to the average flow speed v within the inner tube 300, or respectively inner channel 300*. A second connection opening 800a in the floating-bearing-side coupling 800d is also dimensioned in the same manner, wherein the respective connection opening 500a, or respectively 800a expands to an expanded first 500c, or respectively expanded second passage cross-section 800c in the region of the adjacent tube carrier plate 700, or respectively 800, by a conical first 500b, or respectively a conical second transition 800b.

Depending on the direction of the flow speed v in the inner tube 300, or respectively inner channel 300*, the product P to be treated either flows through the first connection opening 500a or the second connection opening 800a toward the tube bundle 100.1 to 100.n, so that the flow is either toward the fixed-bearing-side tube carrier plate 700, or the floating-bearing-side tube carrier plate 800. Because in each case heat is exchanged between the product P in the inner tubes 300, or respectively the inner channels 300*, and a heat carrier medium W is in a countercurrent in the outer jacket 200, or respectively in the outer channel 200*, this heat carrier medium W either flows toward the first coupling 400a or toward the second coupling 400b at a flow speed c, which exists in the outer jacket 200.

The tube bundle heat exchanger 100 according to the prior art described above with its exemplary design is an embodiment that has been known for decades. Many design alterations with regard to bearing and sealing the tube bundle 100.i are known. The present disclosure needs only a number n of parallel-arranged, series-connected tube bundles 100.i (with i=1 to n). A product P flows through inner tubes 300 of the respective tube bundle 100.i. Viewed in the direction of flow of the product P and with reference to any desired tube bundle 100.i, an outlet A of the tube bundle 100.i is fluidically connected to an inlet E of an adjacent, downstream tube bundle 100.i+1 by an elbow with a deflection angle of 180 degrees. In the same manner, an inlet E of the tube bundle 100.i is connected to an outlet A of an adjacent, upstream tube bundle 100.i−1.

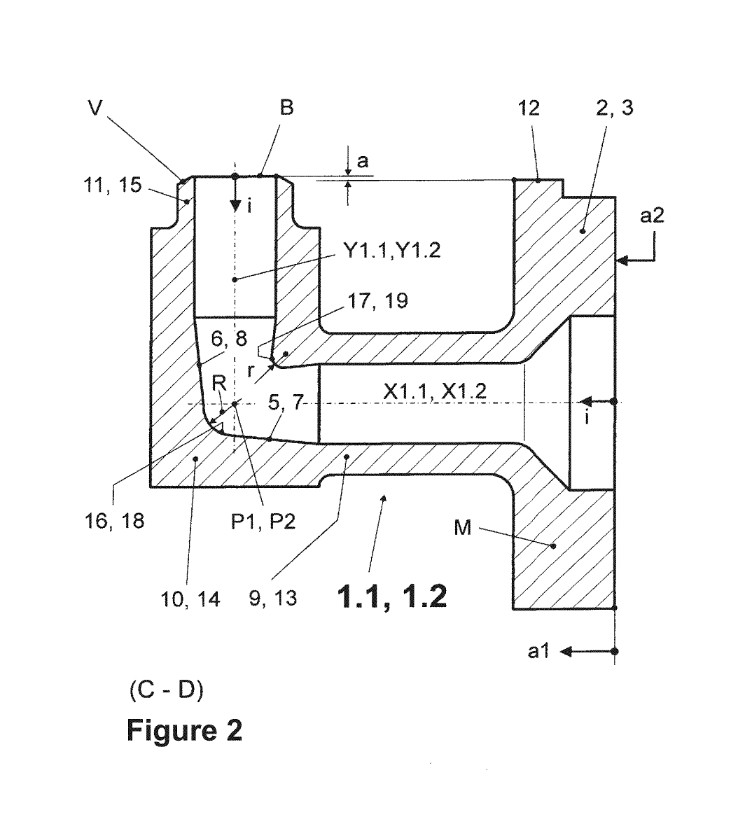

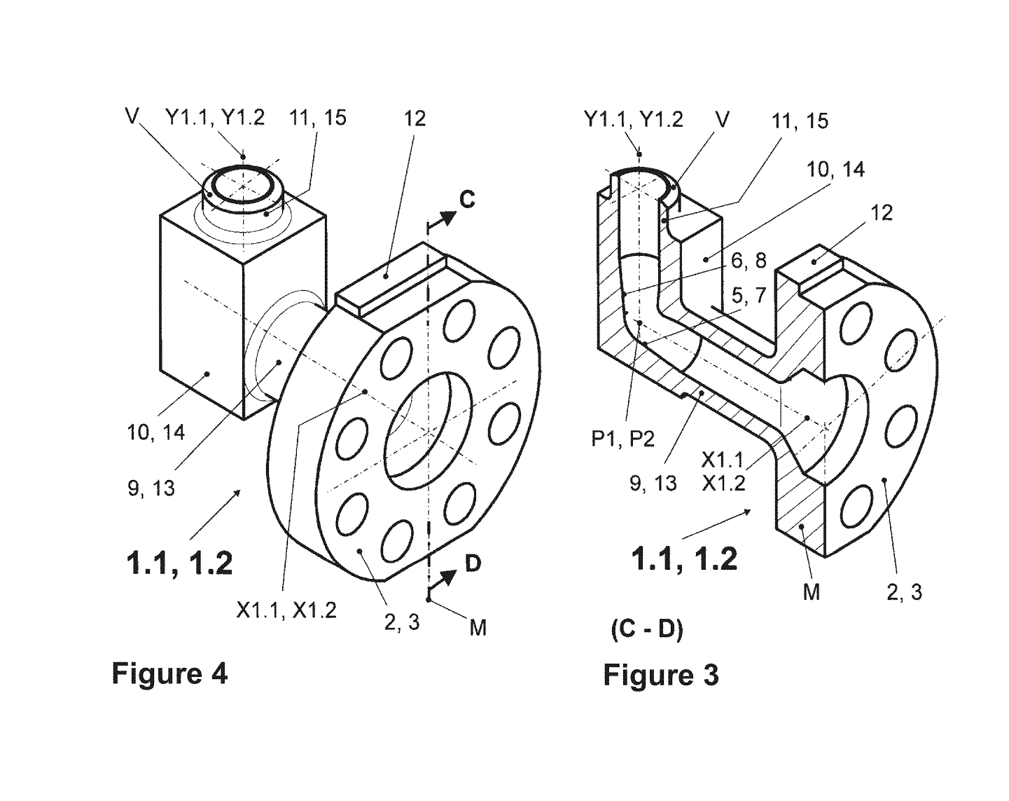

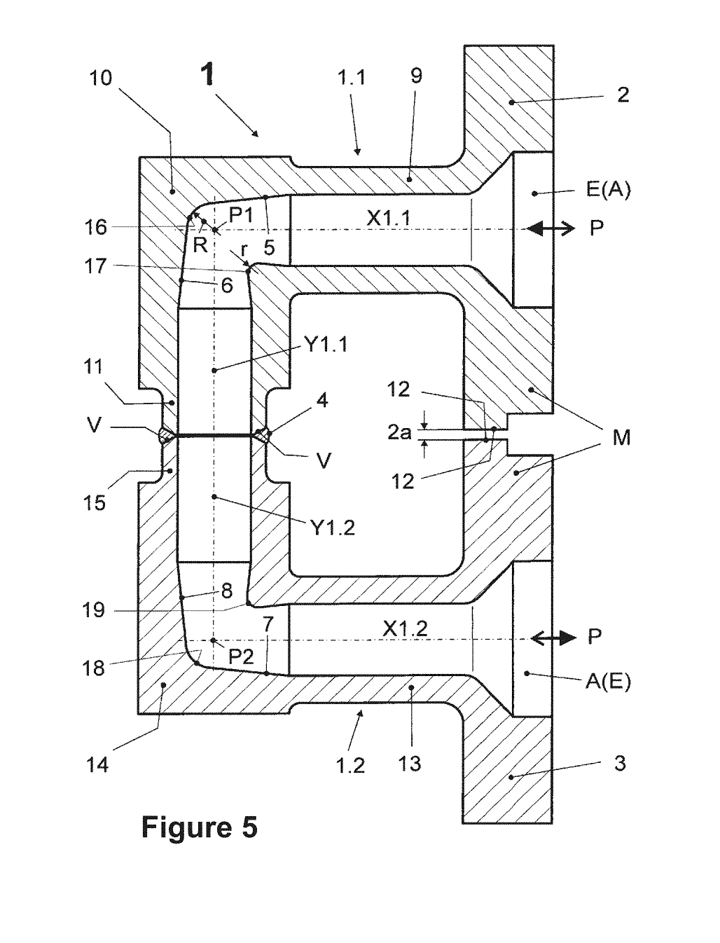

A finished elbow 1 (see FIG. 5) consists of two single-part, preferably congruent elbow halves, a first elbow half 1.1 and a second elbow half 1.2 (see FIGS. 2 to 7). The first elbow half 1.1 is associated with a first flange 2, and the second elbow half 1.2 is associated with a second flange 3. Each elbow half 1.1, 1.2 has a connecting point V on its end facing away from the flange 2, 3. The elbow halves 1.1, 1.2 at the connecting point V are bonded integrally to each other. The integral bond is preferably a weld seam 4, which is preferably performed in a multilayer orbital manner. Each flange 2, 3 can either accommodate the inlet E or the outlet A for the product P, which determines the respective relevant assignment of the flow direction of the product P.

The progression of the passage cross-sections of each elbow half 1.1, 1.2 is formed by rotationally symmetrical passages. On the one hand, at least one passage extends from the first flange 2 in a coaxial arrangement on a first rotational axis X1.1, and on the other hand at least one passage extends from the associated connecting point V in a coaxial arrangement on a second rotational axis Y1.1. In the same manner, at least one passage extends on the one hand from the second flange 3 in a coaxial arrangement on a third rotational axis X1.2, and at least one passage extends on a fourth rotational axis Y1.2 (see FIGS. 2 to 7). In the exemplary embodiment, only one penetrating first passage 5 and one penetrating second passage 6 are indicated in the first elbow half 1.1, and one penetrating third passage 7 and one penetrating forth passage 8 are indicated in the second elbow half 1.2 of these passages in the sequence of the above citation.

The first and second rotational axis X1.1, Y1.1 of the passages 5, 6 of the first elbow half 1.1, and the third and fourth rotational axis X1.2, Y1.2 of the passages 7, 8 of the second elbow half 1.2, run in a common plane that represents a meridian plane M for each flange 2, 3, and they preferably run in a straight line. The first and the second rotational axis X1.1, Y1.2 intersect at a first intersection P1, and the third and the fourth rotational axis X1.2, Y1.2 intersect at a second intersection P2, preferably always at a right angle, i.e., an angle of 90 degrees.

The first intersection P1 is associated with the penetrating first passage 5 on the first rotational axis X1.1 and the penetrating second passage 6 on the second rotational axis Y1.1 that each penetrate each other on one side. In the same manner, the second intersection P2 is assigned to the penetrating third passage 7 on the third rotational axis X1.2, and a penetrating fourth passage 8 on the fourth rotational axis Y1.2 that also each penetrate each other on one side. The first to fourth passages 5, 6 and 7, 8 that each penetrate each other on one side are preferably each designed in the shape of a conical frustum, and their respective tapering is oriented toward the associated first or second intersection P1, P2.

At the first to fourth passages 5, 6 and 7, 8 that penetrate each other, a first convex rounding 16, or respectively a second convex rounding 18 with an outer curvature radius R is provided in the radially exterior progression of the associated passage cross-section of the respective elbow half 1.1, 1.2, and a first concave rounding 17, or respectively a second concave rounding 19 with an inner curvature radius r is provided in the radially interior progression of the associated passage cross-section (see FIG. 2).

The rotationally symmetrical passages of the respective elbow halves 1.1 and 1.2 are lined up with the same diameter at their respective transition point to an adjacent passage to prevent sudden loss-associated cross-sectional transitions, wherein it is moreover advantageous to design these transition points with a continuous curve as provided as an example in the region of the flanges 2, 3 at one point (see FIGS. 2, 5).

The first and second elbow halves 1.1, 1.2 are preferably composed of the following geometric main bodies in the following sequence (see in particular FIG. 4 in conjunction with FIG. 5): the circular cylindrical first flange 2, or respectively circular cylindrical second flange 3, a cylindrical first section 9, or respectively cylindrical fourth section 13, a prismatic second section 10, or respectively prismatic fifth section 14, and a cylindrical third section 11, or respectively a cylindrical sixth section 15.

A contact surface 12 is provided on the first flange 2 and the second flange 3 (see in particular FIG. 2 in conjunction with FIGS. 4 and 5) and is oriented in a plane parallel to an end face B of the connecting point V and stands back by a degree of shrinkage “a” from the end face B. Before the production of the weld seam 4 and in the adjusted end position of the elbow halves 1.1, 1.2, the contact surfaces 12 are distant from each other by double the degree of shrinkage 2a (see FIG. 5). This double degree of shrinkage 2a is dimensioned so that, after the produced weld seam 4 has cooled, the contact surfaces 12 lie on each other, and an immovable and undeformable spacing between the two flanges 2, 3 accordingly exists for their dimensional end processing.

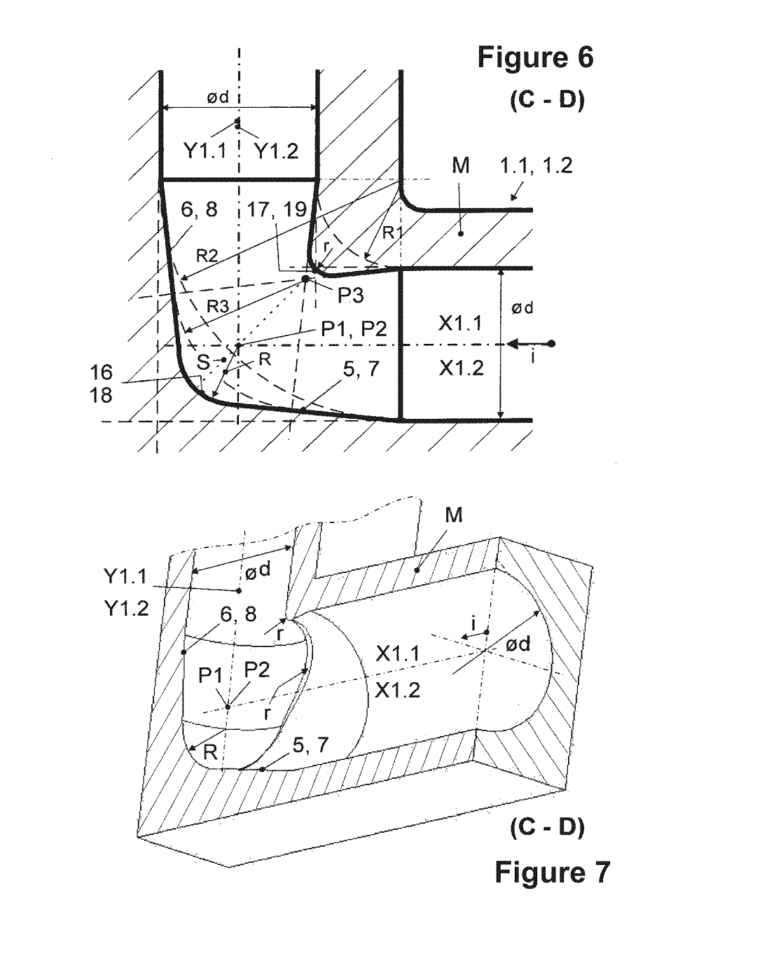

FIG. 6 shows details of an inner contour i of the elbow halves 1.1, 1.2 at their respective deflection region. A “normal” elbow, or respectively a so-called standard bend with a 180 degree deflection with the same inlet and outlet cross-section that is characterized in each case by a diameter Ød, possesses an outer radius R2 (convex rounding) and an inner radius R1 (concave rounding), wherein both differ from each other by the diameter Ød (geometric condition R2=R1+Ød). In contrast to this “normal” elbow, the first elbow half 1.1 has the penetrating first and penetrating second passage 5, 6, each designed in the shape of a conical frustum, which penetrate each other on one side. The geometric relationships in the second elbow half 1.2 with the third and fourth passages 7, 8 that penetrate each other on one side are configured in the same manner. It is apparent that a respective cross-sectional tapering toward a respective peak cross-section S of the elbow half 1.1, 1.2 is established by the respective frusticonical design of the passages 5 to 8 with an expected consequence in terms of fluid mechanics, which has already been addressed above. In order to realize the condition of an equivalent passage cross-section in the region of penetration of the penetrating first passage with the penetrating second passage 5,6, or respectively the penetrating third with the penetrating fourth passage 7, 8, i.e., in the overall peak region of the respective elbow half 1.1, 1.2, said elbow half should be provided with a convex rounding with a radius of a constant passage cross-section R3 in the respective radially exterior progression of the associated passage cross-section, and with a concave rounding in the radially interior progression with the inner curvature radius r.

The design of the inner contour i in the deflection region contrastingly provides expanding the peak cross section S of the elbow half 1.1, 1.2 relative to the peak cross-section S of adjacent passage cross-sections on both sides, which is illustrated by the representation in FIG. 6. The conical, mutually penetrating first to fourth passages 5, 6 and 7, 8 are each concavely rounded with the outer curvature radius R (R<R3) that extends in each case to intersection PI, or respectively P2, which clearly leads to an expansion of the peak cross section S because the first, or respectively second convex rounding 16, 18, extends further to the outside relative to an inner contour established by the radius of a constant passage cross-section R3.

FIG. 7 shows a perspective representation of the penetrating region of the penetrating first with the penetrating second passage opening 5, 6, or respectively the penetrating third with the penetrating fourth passage opening 7, 8 in the radially interior progression of the passage cross-section of the respective elbow half 1.1, 1.2. Without the concave rounding with the inner curvature radius r, a sharp-edge penetrating line would result, which would manifest itself in the meridian plane M in FIG. 6 as a penetration point P3. In any event, in the region of curvature of the elbow, such a sharp-edge penetrating line would cause the flow to be interrupted and hence cause increased elbow loss. To reduce this loss, it is particularly useful when this penetrating line, as shown clearly in FIG. 7, is only partial with varying sharpness over the perimeter, and is concavely rounded over the entire extent of its shape with the inner curvature radius r.

A production method for an elbow 1 having the above-described features includes producing the respective elbow half 1.1, 1.2 from a round material in a first production step, and from a whole piece by machining. An inner contour i consisting of rotationally symmetrical passages and a first outer contour al that is not directly adapted to the tube bundle heat exchanger 100, or respectively its tube bundles 100.1 to 100.n, are provided with a respective end contour. A second outer contour a2 is processed beforehand that is directly adapted to the tube bundle heat exchanger 100. Machining is preferably carried out in this case on a multi-axis machining center on which the flange 2, 3 and cylindrical sections 9, 13 and 11, 15 are turned, the prismatic sections 10, 14 and the contact surfaces 12 are milled, and the passages associated with the rotational axes X1.1, X1.2, Y1.1, Y1.2 are drilled and/or turned.

In a second production step, the two elbow halves 1.1, 1.2 are integrally bonded to each other at their respective connecting point V to the elbow 1. The integral bond is preferably produced by a manual or mechanical orbital welding method which can be carried out in one or more layers.

In a third production step, the second outer contour a2 adapted with the tube bundle heat exchanger 100, or respectively its tube bundles 100.1 to 100.n which expediently also comprises the end-side part of the inlet E or the outlet A is provided with an end contour by machining. In this end contour, the machining of the first and second connection opening 500a, 800a, the conical first and second transition 500b, 800b and the expanded first and expanded second passage cross-section 500c, 800c as described above in conjunction with FIG. 1 are expediently included.

The design of the tube bundle heat exchanger 100 according to FIG. 1 is only to be understood as a possible exemplary embodiment. The invention can be used for any tube bundle heat exchanger that is suitable for large product pressures in which a product flows through inner tubes of a tube bundle, and in which the tube bundles are arranged in parallel and series-connected in a known manner. In such an arrangement viewed in the direction of flow of the product and with reference to any desired tube bundle, an outlet of the tube bundle is fluidically connected to an inlet of an adjacent downstream tube bundle and, alternatingly, an inlet of the tube bundle is fluidically connected to an outlet of an adjacent, preceding tube bundle via an elbow with a deflection angle of 180 degrees. According to the invention, an elbow is used in each case that has the above-described features.

A reference list for the abbreviations and drawing labels is as follows:
1 Elbow
1.1 First elbow half
1.2 Second elbow half
2 First flange
3 Second flange
4 Weld seam
5 Penetrating first passage
6 Penetrating second passage
7 Penetrating third passage
8 Penetrating fourth passage
9 Cylindrical first section
10 Prismatic second section
11 Cylindrical third section
12 Contact surface
13 Cylindrical fourth section
14 Prismatic fifth section
15 Cylindrical sixth section
16 First convex rounding
17 First concave rounding
18 Second convex rounding
19 Second concave rounding
a Degree of shrinkage
a1 First outer contour
a2 Second outer contour
Ød Diameter
i Inner contour
r Inner curvature radius
A Outlet (out of flange 2, 3)
B End face
E Inlet (into flange 2, 3)
M Meridian plane
P1 First intersection
P2 Second intersection
P3 Penetration point
R Outer curvature radius
R1 Inner radius of the normal elbow
R1 Outer radius of the normal elbow
R3 Radius of a constant passage cross-section
S Peak cross section
V Connecting point
X1.1 First rotational axis
X1.2 Third rotational axis
Y1.1 Second rotational axis
Y1.2 Fourth rotational axis
100 Tube bundle heat exchanger
100.1 First tube bundle
100.2 Second tube bundle
100.i i-th tube bundle
100.i−1 Tube bundle upstream from tube bundle 100.i
100.i+1 Tube bundle downstream from tube bundle 100.i
100.n−1 Tube bundle upstream from tube bundle 100.n
100.n n-th tube bundle
200 Outer jacket
200* Outer channel
200a Fixed-bearing-side outer jacket flange
200b Floating-bearing-side outer jacket flange
300 Inner tube
300* Inner channel
400.1 First housing
400a First coupling
400a* First cross channel
400.2 Second housing
400b Second coupling
400b* Second cross channel
500 (Fixed-bearing-side) exchanger flange
500a First connection opening
500b Conical first transition
500c Expanded first passage cross-section
600 Floating-bearing-side exchanger flange
700 Fixed-bearing-side tube carrier plate (tube mirror plate)
800 Floating-bearing-side tube carrier plate (tube mirror plate)
800a Second connection opening
800b Conical second transition
800c Expanded second passage cross-section
800d (Floating-bearing-side) coupling
900 Seal (Flat seal)
910 O-ring
1000 Connecting bend
c Flow speed in the outer jacket
n Number of tube bundles (generally: 100.1, 100.2, . . . , 100.i−1, 100.i, 100.i+1, . . . , 100.n−1, 100.n)
v Average flows speed in the inner tube
A Outlet (outflow side of the tube carrier plate 700, 800)
DTube inner diameter (inner tube 300)
DN Nominal diameter of the connecting bend
E Inlet (inflow side of the tube carrier plate 700, 800)
W Heat carrier medium, general
P Product (temperature-treated side)

1. An elbow with a circular cross-section having a deflection angle of 180 degrees for a tube bundle heat exchanger for large product pressures, having a first and a second flange on each inlet and outlet of the elbow, wherein:
the elbow comprises two one-piece elbow halves,
each elbow half has a connecting point at its end facing away from the flange,
the elbow halves are integrally bonded to each other at the associated
connecting point,
a progression of passage cross-sections of each elbow half is formed by rotationally symmetrical passages, of which at least one extends from the flange, and at least one extends from the associated connecting point in a coaxial arrangement on rotational comprising first, second, third and fourth rotational axes,
the first and second rotational axes of first and second passages of the first elbow half, and the third and fourth rotational axes of third and fourth pas sages of the second elbow half, run in a common plane that represents a meridian plane for each flange,
the first and second rotational axes intersect at a first intersection, and the third and fourth rotational axes intersect at a second intersection,
the first intersection is associated with a penetrating first passage on the first rotational axis, and a penetrating second passage on the second rotational axis that each penetrate each other on one side, and
the second intersection is associated with a penetrating third passage on the third rotational axis, and a penetrating fourth passage on the fourth rotational axis that each penetrate each other on one side.

2. The elbow according to claim 1, wherein:
at the first to fourth passages that penetrate each other in pairs, a convex rounding with an outer curvature radius is provided in the radially exterior progression of the associated passage cross-section of the respective elbow half, and a concave rounding with an inner curvature radius is provided in the radially interior progression of the associated passage cross-section.

3. The elbow according to claim 1, wherein:
the first to fourth passages are each designed in the shape of a conical frustum, and their respective tapering is oriented toward the associated first or second intersection.

4. The elbow according to claim 1, wherein:
a peak cross section of each elbow half is expanded relative to the peak cross-section of adjacent passage cross-sections on both sides.

5. The elbow according to claim 1, wherein:
the rotationally symmetrical passages are lined up with the same diameter at their respective transition point to an adjacent passage.

6. The elbow according to claim 5, wherein:
the transition points are consistently designed curved.

7. The elbow according to claim 1, wherein:
the rotational axes each run in a straight line.

8. The elbow according to claim 1, wherein:
the first and second rotational axes, and the third and fourth rotational axes each intersect at an angle of 90 degrees.

9. The elbow according to claim 1, wherein:
the elbow halves are designed congruent.

10. The elbow according to claim 1, wherein:
an integral bond of the connecting points is a weld connection.

11. The elbow according to claim 10, wherein:
the weld connection is formed in a multilayer orbital manner.

12. The elbow according to claim 1, wherein:
a contact surface is provided on the flange, which is oriented in a plane parallel to an end face of the connecting point and that stands back by a degree of shrinkage from the end face.

13. A production method for an elbow according to claim 1, comprising:
producing the respective elbow half from round material and from a whole piece by machining,
wherein an inner contour consisting of rotationally symmetrical passages and a first outer contour that is not directly adapted to the tube bundle heat exchanger, or respectively its tube bundles, are provided with a respective end contour, and a second outer contour is processed beforehand that is directly adapted to the tube bundle heat exchanger, or respectively its tube bundles;
integrally bonding the two elbow halves to each other at their respective connecting point to the elbow; and
adapting the second outer contour to the tube bundle heat exchanger, or respectively its tube bundles, by machining an end contour.

14. The production method according to claim 13, wherein integrally bonding the two elbow halves comprises:
producing an integral bond of the two elbow halves by an orbital welding method.

15. The production method according to claim 14, wherein:
the orbital welding method is performed in multiple layers.

16. The production method according to claim 14,
performing stress-relief annealing at least once following conclusion of the orbital welding method, or during a multi-layer orbital welding method.

17. The production method according to claim 13 wherein:
a contact surface provided on each of the first and second flange is positioned by a degree of shrinkage such that, after integrally bonding, a mutual contacting of the contact surfaces resulting from contraction by cooling regions of the elbow heated during integral bonding ensures that the second outer contour is produced with the dimensionally accurate end contour.

18. A tube bundle heat exchanger for large product pressures with series-connected tube bundles arranged in parallel, wherein a product flows through inner tubes of the tube bundle and, viewed in the direction of flow of the product and with reference to any desired tube bundle, an outlet of the tube bundle is fluidically connected to an inlet of an adjacent downstream tube bundle and, alternatingly, an inlet of the tube bundle is fluidically connected to an outlet of an adjacent, upstream tube bundle via an elbow with a deflection angle of 180 degrees according to claim 1.

19. A use of a tube bundle heat exchanger for large product pressures according to claim 18 in a spray drying system directly before or at a short distance from the nozzle in the drying tower.
